(19) United States
(12) Patent Application Publication
(10) Pub. No.: US 2018/0138821 A1
(43) Pub. Date: May 17, 2018

(54) IMPROVEMENTS IN OR RELATING TO VOLTAGE SOURCE CONVERTERS

(71) Applicant: General Electric Technology GmbH, Baden (CH)

(72) Inventors: Francisco Jose MORENO MUNOZ, Stafford (GB); Konstantin VERSHININ, Stafford (GB)

(21) Appl. No.: 15/566,813

(22) PCT Filed: Apr. 14, 2016
(86) PCT No.: PCT/EP2016/058265

§ 371 Date: Oct. 16, 2017

(30) Foreign Application Priority Data
Apr. 17, 2015 (GB) 1506560.0

(51) Int. Cl. H02M 7/06; H02M 7/08

(52) U.S. Cl. CPC H02M 7/064; H02M 7/08

(57) ABSTRACT

A voltage source converter comprises a converter limb including first and second DC terminals for connection to a DC network. Each converter limb includes first and second limb portions which are separated by an AC terminal for connection to an AC network. Each limb portion includes a switching element connected with a chain-link converter that is operable to provide variable voltage. The voltage source converter includes a control unit to switch the switching element in each of the first and second limb portions between conducting and non-conducting configurations to selectively switch the corresponding chain-link converter, each switching element while in its non-conducting configuration transitions between a non-voltage supporting state and a voltage supporting state; and operate each chain-link converter while switched out of circuit to generate a varying voltage waveform to reduce the voltage range the corresponding switching element is exposed to in its voltage supporting state.

### BACKGROUND OF THE INVENTION

This invention relates to a voltage source converter for use in high voltage direct current (HVDC) power transmission.

In HVDC power transmission, alternating current (AC) electrical power is converted to high voltage direct current (DC) power for transmission via overhead lines and/or undersea cables. This conversion reduces the cost per kilometre of the lines and/or cables, and is therefore cost-effective when power needs to be transmitted over a long distance. Once the transmitted electrical power reaches its target destination, the high voltage DC electrical power is converted back to AC electrical power before being distributed to local networks.

The conversion of AC power to DC power is also commonly utilized in power transmission networks in circumstances where it is necessary to interconnect two AC networks operating at different frequencies.

Converters are required at each interface between AC and DC networks to effect the required conversion between AC power and DC power, and one such form of converter is a voltage source converter.

### BRIEF DESCRIPTION OF THE INVENTION

According to the invention there is provided a voltage source converter, for use in high voltage DC power transmission, comprising: at least one converter limb including first and second DC terminals for connection in use to a DC network, the or each converter limb including first and second limb portions separated by an AC terminal for connection in use to an AC network, each limb portion including a primary switching element connected in series with a chain-link converter operable to provide a stepped variable voltage; and a control unit programmed to: switch the primary switching element in each of the first and second limb portions between conducting and non-conducting configurations to selectively switch the corresponding chain-link converter in and out of circuit, whereby each primary switching element while in its non-conducting configuration transitions between a non-voltage supporting state and a voltage supporting state; and operate each chain-link converter while switched out of circuit to generate a varying voltage waveform to reduce the voltage range the corresponding primary switching element is exposed to while in its voltage supporting state configuration.

Reducing the voltage range that each primary switching element is exposed to while in its voltage supporting state allows for a simplification in the design and operation of one or more auxiliary circuits associated with each primary switching element.

For example, the operation of a snubber capacitor and DC grading resistor which might accompany a given primary switching element, e.g. to help share voltages more equally across individual switches within a primary switching element and thereby avoid peak voltages that might otherwise damage or destroy one or more such individual switches, can be optimised since they do not have to accommodate divergent upper and lower voltages across a wide voltage range. As a consequence any losses associated with such operation of the snubber capacitor and resistor can be minimised.

This in turn avoids, for example, the need for stepped activation and deactivation of individual switches within a given primary switching element which would otherwise impact adversely on the ability to scavenge power from the associated primary switching element to help power various control systems associated with operation of the voltage source converter.

In an embodiment the control unit is programmed to operate each chain-link converter while switched out of circuit to generate a varying voltage waveform to maintain the voltage the corresponding primary switching element is exposed to while in its voltage supporting state to within a voltage range having a deviation between its upper and lower limits of not more than 20%.

Optionally the control unit is programmed to operate each chain-link converter while switched out of circuit to generate a varying voltage waveform to maintain the voltage the corresponding primary switching element is exposed to while in its voltage supporting state to within a voltage range having a deviation between its upper and lower limits of less than 10%.

Maintaining the voltage a given primary switching element is exposed to while in its voltage supporting state to within the aforementioned voltage ranges provides in each instance the opportunity to optimise to a desired extent the design and operation of one or more auxiliary circuits associated with a given primary switching element.

In an embodiment of the invention the control unit is programmed to operate each chain-link converter while switched out of circuit to generate a varying voltage waveform to maintain at a constant level the voltage the corresponding primary switching element is exposed to while in its voltage supporting state.

The ability to maintain at a constant level the voltage each primary switching element is exposed to while in its voltage support state means that a given primary switching element operates during such a period in a configuration and under voltage conditions for which it was originally designed, i.e. fully switched off with negligible current flowing therethrough and with a constant, full voltage thereacross. Such operation of the primary switching element has already been optimised by the original designer and manufacturer, and hence the primary switching element is able to operate in a most optimal manner within the voltage source converter of the invention.

In an embodiment the control unit is programmed to operate each chain-link converter to generate a varying voltage waveform which has a shape identical to a voltage waveform that the corresponding primary switching element would be exposed to while in its voltage supporting state if the said chain-link converter instead generated a constant maximum voltage while switched out of circuit.

A control unit so programmed desirably achieves operating conditions in which the corresponding primary switching element is exposed to a constant voltage while in its voltage supporting state and so is able to perform in an optimum manner.

The control unit may be programmed to operate each chain-link converter while switched out of circuit to generate a varying voltage waveform which incorporates a maximum voltage the corresponding chain-link converter is able to provide.

Having a control unit programmed to operate each chain-link converter in such a manner minimises the peak voltage that the corresponding primary switching element is exposed to while in its voltage supporting state, and so allows for the inclusion of a primary switching element with a lower voltage rating which is typically less expensive than a commensurate primary switching element with a higher voltage rating.

Optionally the control unit is further programmed to operate each chain-link converter while the corresponding primary switching element is in its non-conducting configuration and transitioning between the non-voltage supporting state and the voltage supporting state to generate a transitional voltage waveform to control the rate of change of voltage the said primary switching element is exposed to while transitioning between the said non-voltage supporting and voltage supporting states.

The ability to control the rate of change of voltage the said primary switching element is exposed to while transitioning between non-voltage supporting and voltage supporting states is desirable since it can help to reduce any losses associated with such transitioning. It addition it can help reduce the amount of electromagnetic interference generated by the voltage source converter.

In another embodiment of the invention the control unit is further programmed to operate each chain-link converter while the corresponding primary switching element is transitioning between its non-voltage supporting and voltage supporting states to generate a transitional voltage waveform to limit to a predetermined level the rate of change of voltage the said primary switching element is exposed to.

Limiting to a predetermined level the rate of change of voltage the said primary switching element is exposed to is particularly advantageous as it can additionally help to ensure that the given primary switching element operates at all times within its performance limits.

### BRIEF DESCRIPTION OF THE DRAWINGS

There now follows a brief description of embodiments of the invention, by way of non-limiting example, with reference being made to the following drawings in which:

FIG. 1 shows a schematic view of a voltage source converter;

FIG. 2 illustrates varying voltage waveforms generated by respective chain-link converters in the voltage source converter shown in FIG. 1, along with the resulting voltage across a corresponding primary switching element;

FIG. 3 illustrates a comparative voltage across a primary switching element while in a non-conducting configuration; and

FIG. 4 illustrates an enlarged portion of one of the varying voltage waveforms shown in FIG. 2 and accompanying voltage across the corresponding primary switching element.

### DETAILED DESCRIPTION OF THE INVENTION

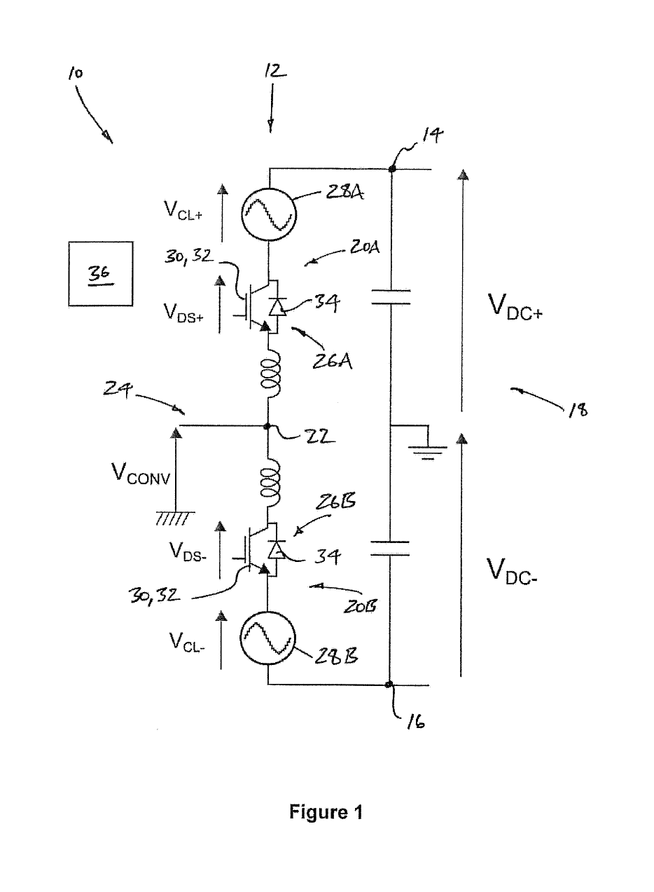

A voltage source converter according to a first embodiment of the invention is designated generally by reference numeral 10, as shown in FIG. 1.

The voltage source converter 10 includes a converter limb 12 which has first and second DC terminals 14, 16 that are, in use, connected to a DC network 18. The first DC terminal 14 carries a voltage V_{DC+} while the second DC terminal 16 carries a voltage of V_{DC-}. The converter limb 12 includes first and second limb portions 20A, 20B that are separated by an AC terminal 22 which is, in use, connected to an AC network 24.

Voltage source converters (not shown) according to other embodiments of the invention may include more than one converter limb and may, for example, include three converter limbs each of which corresponds to a respective phase of an associated three-phase AC network.

Returning to the embodiment shown in FIG. 1, the first limb portion 20A includes a first primary switching element 26A which is connected in series with a first chain-link converter 28A, and the second limb portion 20B includes a second primary switching element 26B that is connected in series with a second chain-link converter 28B.

Each chain-link converter 28A, 28B is operable to provide a stepped variable voltage.

More particularly, in the embodiment shown each chain-link converter 28A, 28B includes a plurality of first chain-link modules (not shown) in which first and second pairs of secondary switching elements and a capacitor are connected in a known full bridge arrangement to define a 4-quadrant bipolar module. Switching of the secondary switching elements selectively directs current through the capacitor or causes current to bypass the capacitor such that the first module can provide zero, positive or negative voltage and can conduct current in two directions.

In other embodiments of the invention one or both of the chain-link converters 28A, 28B may instead include a plurality of second chain-link modules in which only a first pair of secondary switching elements is connected in parallel with a capacitor in a known half-bridge arrangement to define a 2-quadrant unipolar module. In a similar manner to the aforementioned first chain-link module, switching of the secondary switching elements again selectively directs current through the capacitor or causes current to bypass the capacitor such that the second module can provide zero or positive voltage and can conduct current in two directions.

In each instance it is possible to build up a combined voltage across each chain-link converter 28A, 28B, via the insertion of the capacitors of multiple chain-link modules (with each module providing its own voltage), which is higher than the voltage available from each individual module.

Accordingly, the chain-link modules work together to permit the respective chain-link converter 28A, 28B to provide the aforesaid stepped variable voltage. This permits the generation of a voltage waveform across each chain-link converter 28A, 28B using a step-wise approximation. Operation of each chain-link converter 28A, 28B in this manner can, for example, be used to generate an AC voltage waveform V_{CONV} at the AC terminal 22, and thereby enable the voltage source converter 10 to provide a power transfer functionality between the AC and DC networks 24, 18.

In the meantime, each primary switching element 28A, 28B includes a plurality of series-connected individual switches 30 (only one of which is shown in FIG. 1). Each individual switch 30 is a semiconductor device in the form of, e.g. an Insulated Gate Bipolar Transistor (IGBT) 32, which is connected in parallel with an anti-parallel diode 34. It is, however, possible to use other semiconductor devices or indeed only one semiconductor device or other individual switch.

In addition, in other embodiments of the invention one or both of the first and second limb portions 20A, 20B may have a different arrangement of primary switching element and corresponding chain-link converter to that described hereinabove, and may furthermore include one or more additional components.

Returning again to the embodiment shown in FIG. 1, the voltage source converter 10 also includes a control unit 36 that is arranged in operative communication with each primary switching element 26A, 26B and each chain-link converter 28A, 28B. Although only a single control unit 36 is shown in FIG. 1, in other embodiments of the invention the control unit 36 may be made up of a plurality of control sub-modules and/or may be distributed across more than one separate control sub-unit.

In any event, the control unit 36 is programmed to switch the primary switching element 26A, 26B in each of the first and second limb portions 20A, 20B between conducting and non-conducting configurations, to selectively switch the corresponding chain-link converter 28A, 28B in and out of circuit, i.e. in and out of the corresponding limb portion 20A, 20B. While in its non-conducting configure, each primary switching element 26A, 26B transitions between a non-voltage supporting state in which the voltage thereacross is zero, i.e. the primary switching element 26A, 26B supports no voltage, and a voltage supporting state in which the voltage thereacross is non-zero, i.e. the primary switching element 26A, 26B is in a “blocking” state in which it supports a voltage.

The control unit 36 is also programmed to operate each chain-link converter 28A, 28B while it is switched out of circuit, and more particularly while each corresponding primary switching element 26A, 26B is in its voltage supporting state, to generate a varying voltage waveform to reduce the voltage range the corresponding primary switching element 26A, 26B is exposed to while it is in the aforesaid voltage supporting state.

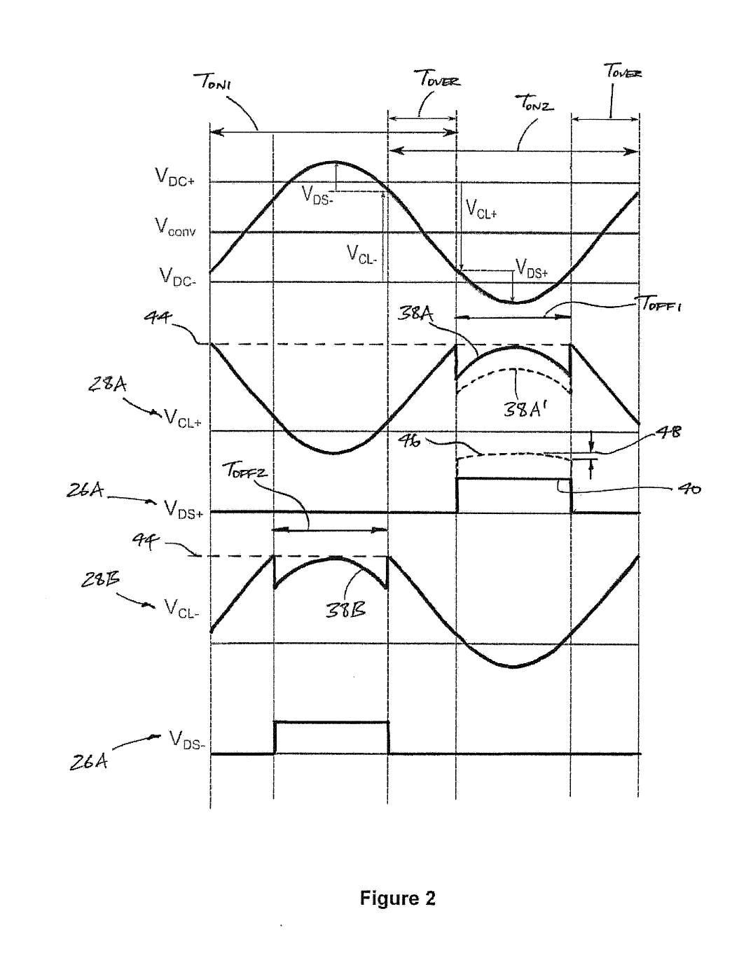

More particularly still the control unit 36 is, with reference to FIG. 2, programmed to operate each chain-link converter 28A, 28B as follows.

During normal operation of the voltage source converter 10 the first primary switching element 26A is switched into its conducting configuration, i.e. during a first conducting period T_{ON1}, and the second primary switching element 26B is switched into its conducting configuration, i.e. during a second conducting period T_{ON2}, and the voltage within each limb portion 20A, 20B is supported solely by the corresponding chain-link converter 28A, 28B.

The first and second conducting periods T_{ON1}, T_{ON2} may overlap with one another, e.g. during an overlap period T_{OVER} during which both the first and second primary switching elements 26A, 26B are in their respective conducting configurations.

Following the overlap period T_{OVER} (if included), the primary switching element 26A, 26B in the limb portion 20A, 20B not intended to operate for the next part in the operating cycle of the voltage source converter 10 is switched into its non-conducting configuration.

For example, following the first conducting period T_{ON1}, the first primary switching element 26A is switched by the control unit 36 into its non-conducting configuration and remains in this configuration for a first non-conducting period T_{OFF1}. In the embodiment shown, as soon as the first primary switching element 26A is switched into its non-conducting configuration it transitions, i.e. during a first transitioning period T_{TRAN1} (as shown in FIG. 4), from a non-voltage supporting state to a voltage supporting state. In other embodiments of the invention, however, there may be a delay after being switched into its non-conducting configuration before the first primary switching element 26A carries out such a transition.

In any event, when the first primary switching element 26A is in its voltage supporting state the voltage within the first limb portion 20A is supported by both the first chain-link converter 28A and the first primary switching element 26A, such that

V_{CONV}+V_{DS+}+V_{CL+}−V_{DC+}=0

where, V_{CONV} is the voltage at the AC terminal 22; V_{DS+} is the voltage across the first primary switching element 26A, i.e. the voltage supported by the first primary switching element 26A; V_{CL+} is the voltage across the first chain-link converter 28A; and V_{DC+} is the voltage at the first DC terminal 14.

With respect to the foregoing any additional voltage across an inductance within the first limb portion 20A is considered negligible and so is ignored.

While the first primary switching element 26A is in the aforementioned voltage supporting state, i.e. within the first non-conducting period T_{OFF1} in which the first primary switching element 26A has switched the first chain-link converter 28A out of circuit, the control unit 36 operates the first chain-link converter 28A to generate a first varying voltage waveform 38A which maintains at a constant level 40 the voltage V_{DC+} that the first primary switching element 26A is exposed to while in the said voltage supporting state. In this manner the first primary switching element 26A is exposed to a voltage range of zero.

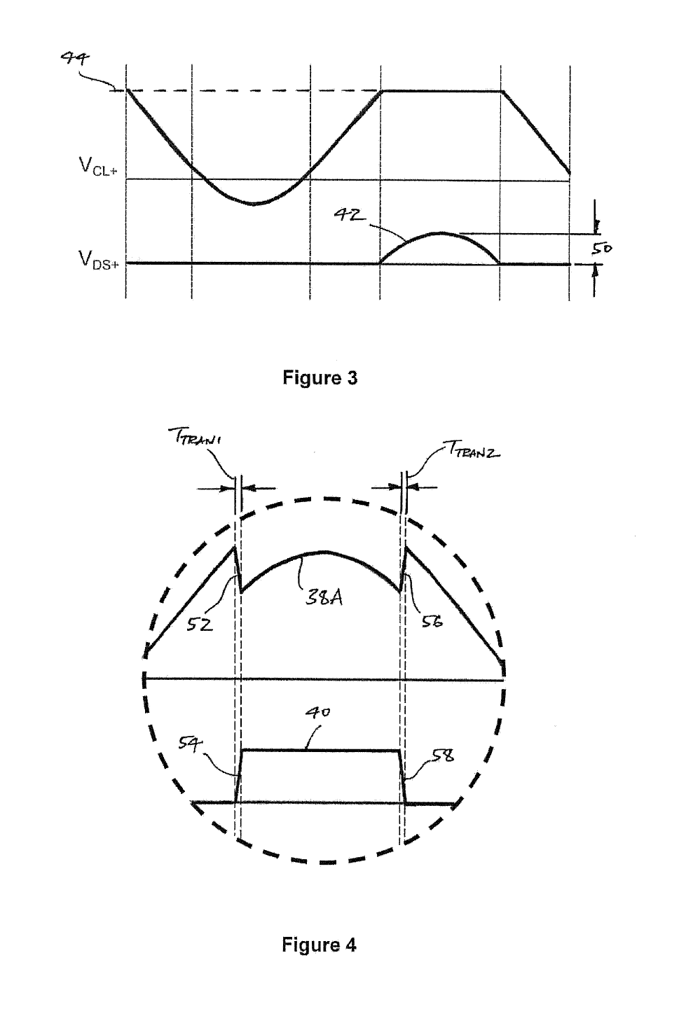

More particularly, the control unit 36 operates the first chain-link converter 28A to generate a varying voltage waveform 38A which has a shape identical to a voltage waveform 42 that the first primary switching element 26A would be exposed to while in its voltage supporting state if the first chain-link converter 28A instead generated a constant maximum voltage 44 while the first primary switching element 26A is in such a voltage supporting state, as shown in FIG. 3.

More particularly still, the control unit 36 operates the first chain-link converter 28A to generate a varying voltage waveform 38A which additionally incorporates the maximum voltage 44 the first chain-link converter 28A is able to provide.

In other embodiments of the invention the control unit 36 may instead operate the first chain-link converter 28A to generate a varying voltage waveform 38A′ which has a different shape, e.g. as shown in dashed line in FIG. 2.

In such embodiments the first primary switching element 26A is, while in its voltage supporting state, exposed to a varying level of voltage 46 (as again shown in dashed line in FIG. 2) that has an alternative voltage range 48 which deviates between upper and lower limits by less than 10%.

In both of the aforementioned embodiments, the first primary switching element 26A is exposed to a reduced voltage range 40; 48, e.g. compared to a comparative voltage range 50 that arises in the comparative example shown in FIG. 3.

Returning to the principal embodiment illustrated in FIG. 2, the control unit 36 is further programmed to operate the first chain-link converter 28A while the first primary switching element 26A is in its non-conducting configuration and initially transitioning from a non-voltage supporting state to a voltage supporting state, i.e. during the first transitioning period T_{TRAN1} shown in FIG. 4, to generate a first transitional voltage waveform 52 to control, and more particularly limit, the rate of change of voltage that the first primary switching element 26A is exposed to while transitioning from its non-voltage supporting state to its voltage supporting state.

In this regard the rate of change of voltage the first primary switching element 26A is exposed to is determined by the gradient of a first voltage waveform portion 54 during the said first transitioning period T_{TRAN1} which, as can be seen from FIG. 4, is essentially constant and so represents constant, i.e. limited, level of voltage change.

The control unit 36 is still further programmed to operate the first chain-link converter 28A while the first primary switching element 26A remains in its non-conducting configuration and finally transitions from the voltage supporting state back to the non-voltage supporting state, i.e. during a second transitioning period T_{TRAN2} (as also shown in FIG. 4), to generate a second transitional voltage waveform 56 to control, and more particularly limit, the rate of change of voltage that the first primary switching element 26A is exposed to while transitioning from its voltage supporting state to its non-voltage supporting state.

Accordingly, as can be seen from FIG. 4, the resulting gradient of a corresponding second voltage waveform portion 58 during the said second transitioning period T_{TRAN2} is similarly essentially constant, and so represents a constant, limited level of voltage change.

As can also be seen from FIG. 4 in combination with FIG. 2, in this embodiment shown as soon as the first primary switching element 26A has transitioned into its non-voltage supporting state it is immediately switched back into its conducting configuration, although this need not necessarily be the case in other embodiments of the invention.

Operation of the voltage source converter 10 with respect to the voltage range the second primary switching element 26B is exposed to while in its voltage supporting state, is essentially the same as described hereinabove with respect to the first primary switching element 26A.

To that end, following the second conducting period T_{ON2}, the second primary switching element 26B is switched by the control unit 36 into its non-conducting configuration and remains in this configuration for a second non-conducting period T_{OFF2}. Immediately after being switched into its non-conducting configuration the second primary switching element 26B transition from its non-voltage supporting state to its voltage supporting state.

When the second primary switching element 26B is in its voltage supporting state the voltage within the second limb portion 20B is similarly supported by both the second chain-link converter 28B and the second primary switching element 26B, such that

V_{CONV}+V_{DS-}+V_{CL-}−V_{DC-}=0

where, V_{CONV} is the voltage at the AC terminal 22; V_{DS-} is the voltage across the second primary switching element 26B i.e. the voltage supported by the second primary switching element 26B; V_{CL-} is the voltage across the second chain-link converter 28B; and V_{DC-} is the voltage at the second DC terminal 16.

Again, with respect to the foregoing any additional voltage across an inductance within the second limb portion 20B is considered negligible and so is ignored.

Furthermore, while the second primary switching element 26B is in the aforementioned voltage supporting state, i.e. within the second non-conducting period T_{OFF2} in which the second primary switching element 26B has switched the second chain-link converter 28B out of circuit, the control unit 36 similarly operates the second chain-link converter 28B to generate a second varying voltage waveform 38B which maintains at a constant level 40 the voltage VDS− that the second primary switching element 26B is exposed to while in the said voltage supporting state. In this manner the second primary switching element 26B is similarly exposed to a voltage range of zero.

In addition, the control unit 36 is again further programmed to operate the second chain-link converter 28B while the second primary switching element 26B is in its non-conducting configuration and transitioning between its non-voltage supporting and voltage supporting states to generate a corresponding transitional voltage waveform (not shown) to limit to a predetermined level the rate of change of voltage the second primary switching element 26B is exposed to while transitioning between its said non-voltage supporting and voltage supporting states.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A voltage source converter, for use in high voltage DC power transmission, comprising:
at least one converter limb including first and second DC terminals for connection in use to a DC network, the or each converter limb including first and second limb portions separated by an AC terminal for connection in use to an AC network, each limb portion including a primary switching element connected in series with a chain-link converter operable to provide a stepped variable voltage; and
a control unit programmed to:
switch the primary switching element in each of the first and second limb portions between conducting and non-conducting configurations to selectively switch the corresponding chain-link converter in and out of circuit, whereby each primary switching element while in its non-conducting configuration transitions between a non-voltage supporting state and a voltage supporting state; and
operate each chain-link converter while switched out of circuit to generate a varying voltage waveform to reduce the voltage range the corresponding primary switching element is exposed to while in its voltage supporting state.

2. The voltage source converter according to claim 1 wherein the control unit is programmed to operate each chain-link converter while switched out of circuit to generate a varying voltage waveform to maintain the voltage the corresponding primary switching element is exposed to while in its voltage supporting state to within a voltage range having a deviation between its upper and lower limits of not more than 20%.

3. The voltage source converter according to claim 2 wherein the control unit is programmed to operate each chain-link converter while switched out of circuit to generate a varying voltage waveform to maintain the voltage the corresponding primary switching element is exposed to while in its voltage supporting state to within a voltage range having a deviation between its upper and lower limits of less than 10%.

4. The voltage source converter according to claim 1 wherein the control unit is programmed to operate each chain-link converter while switched out of circuit to generate a varying voltage waveform to maintain at a constant level the voltage the corresponding primary switching element is exposed to while in its voltage supporting state.

5. The voltage source converter according to claim 4 wherein the control unit is programmed to operate each chain-link converter to generate a varying voltage waveform which has a shape identical to a voltage waveform that the corresponding primary switching element would be exposed to while in its voltage supporting state if the said chain-link converter instead generated a constant maximum voltage while switched out of circuit.

6. The voltage source converter according to claim 1 wherein the control unit is programmed to operate each chain-link converter while switched out of circuit to generate a varying voltage waveform which incorporates a maximum voltage the corresponding chain-link converter is able to provide.

7. The voltage source converter according to claim 1 wherein the control unit is further programmed to operate each chain-link converter while the corresponding primary switching element is in its non-conducting configuration and transitioning between the non-voltage supporting state and the voltage supporting state to generate a transitional voltage waveform to control the rate of change of voltage the said primary switching element is exposed to while transitioning between the said non-voltage supporting and voltage supporting states.

8. The voltage source converter according to claim 7 wherein the control unit is further programmed to operate each chain-link converter while the corresponding primary switching element is transitioning between its non-voltage supporting and voltage supporting states to generate a transitional voltage waveform to limit to a predetermined level the rate of change of voltage the said primary switching element is exposed to.
